(19) United States
(12) Patent Application Publication
(10) Pub. No.: US 2026/0035269 A1
(43) Pub. Date: Feb. 5, 2026

(54) Low-Energy Desalination Methodology

(71) Applicant: Mark L. Witten, Tucson, AZ (US)

(72) Inventor: Mark L. Witten, Tucson, AZ (US)

(21) Appl. No.: 18/771,952

(22) Filed: Aug. 5, 2024

(51) Int. Cl. C02F 1/26; C02F 103/08

(52) U.S. Cl. CPC C02F 1/265; C02F 2103/08; C02F 2201/002

(57) ABSTRACT

This new low-energy desalination methodology using pure magnesium disks has vastly increased the salt extraction efficiency from 31.7% with pure silicon disks to over 99% with pure magnesium disks. This huge increase in extraction efficiency was executed with just enough energy use to have the saltwater move over the magnesium disk. We expect this desalination methodology to revolutionize fresh water production on a worldwide level because of the vast decrease in energy used and portability of the low-energy desalination system.

### CROSS REFERENCE TO RELATED APPLICATION

This application is a national stage application under 35 U.S.C. § 371 of, and claims priority from, International Application No. PCT/US 63/628,714, filed 16 Aug. 2023, which is herein incorporated by reference in its entirety. This application is also related to U.S. Pat. No. 8,628,625B issued on 14 Jan. 2014.

There was no Federally sponsored research or development used in the development of this invention.

### BACKGROUND OF THE INVENTION

The present state-of-the art world-wide in desalination isdominated by reverse-osmosis and flash desalination. The new San Diego, California reverse-osmosis desalination plant produces 55 million gallons of fresh water daily at the energy use of approximately 900 megawatts. Additionally, the salty brine is deposited in the Pacific Ocean. I have toured flash desalination plants in the Kingdom of Saudi Arabia. These plants use oil as a power source and simply boil the seawater and collect the steam condensate. The Kingdom of Saudi Arabia produces approximately 8-9 million barrels of crude oil daily and uses 10% of crude oil production for flash desalination. Additionally, the collected salt is dumped into the Indian Ocean. Our new low-energy desalination methodology is planned to be completely sustainable.

Our energy use in this new desalination methodology is minimal with just enough energy to move our magnesium plates through the salt water on a Christmas-tree like device. We estimate our future desalination plant will operate with solar/wind and batteries at night at an energy use of less than 5 megawatts daily. We will also collect the salt after desalination to mine this salt for lithium, magnesium, and other elements such as gold and silver. We will then use the sea salt to establish very large green houses to grow sea algae. Sea algae is rich in nutrients and chemical energy. (hydrocarbons) enough for the US Air Force to make synthetic jet fuel from sea algae. We will also make food pellets from sea algae for animal and human consumption. The mined lithium will be used for the electric vehicle industry and we will use the collected magnesium to make additional magnesium desalination plates. We can state unequivocally our new low-energy desalination methodology will be totally sustainable. Our low-energy desalination technology is also portable which opens our desalination technology to removing salt from agricultural wells so that salt-sensitive agricultural crops can be grown. Another serious issue is salt water intrusion into coastal fresh water aquifers due to rising sea levels and our portable low-energy desalination methodology can be set up near these threatened coastal fresh water aquifers, produce fresh water from ocean water, and then inject this fresh water into the aquifers and force. the salt water back into the ocean. Vietnam has lost a substantial portion of its rice crop because rice is not salt tolerant to sea water intrusion.

### SUMMARY AND DETAILED DESCRIPTION OF THE INVENTION

We have developed a low-energy desalination process using

Dipalmitoylphosphatidylcholine (DPPC) spray-coated to a pure silicon disk starting with a 2-inch diameter disk and up scaling the silicon disk to 4 inches, 6 inches, and finally 12-inch diameter silicon disk.

This low-energy desalination process was upgraded by switching from DPPC to dioylpalmitoyphosphatidylcholine, (DOPC, C44H84NOSP, molecular weight of 786.1) which increased a first passage of approximately 31.7% salt extraction.

In these new experiments, we used a pure magnesium disk 12 inches in diameter and 4 millimeters in thickness. This magnesium disk was manufactured by American Elements Company In Los Angeles. This disk was spray-coated with 8 milliliters of dipalmitoyphosphatidylcholine (DOPC) and placed in an aluminum tub filled with salt water at a concentration of 35,000 parts per million which is the salinity of the Earth's oceans. The salt water was at room temperature of approximately 24 degrees Centigrade. The tub was placed on a laboratory rocker set at 30 revolutions per minute which was just enough energy to have the saltwater move over the magnesium disk.

After 2 hours of this low-energy desalination process, the rocker was stopped and the salt-encrusted disk was removed from the aluminum tub. We waited for 30 minutes to allow the salt/DOPC/magnesium complex to settle on the bottom of the aluminum tub. A water sample was taken from the aluminum tub and measured with a standard multifunction salinity meter. Three complete experiments were performed on separate days and the average water salinity concentration was 328.33 parts per million with a standard error of the mean (sem) of 1.92 ppm. These data correspond to a 99.062% salt extraction. These data demonstrate a substantial improvement in the low-energy desalination state-of-the-art by switching from a pure silicon disk to a pure magnesium disk and increasing salt extraction from 31.7% to 99.062%, an increase of 67.362%.

1. The use of a pure magnesium disk coated with dipalmitoylphosphatidylcholine has vastly increased the extraction of salt from 35,000 ppm salt water from 31.7% to over 99% which has greatly advanced the state-of-the-art of low energy desalination. These 12-inch diameter pure magnesium disks will be set up in a 2 cubic meter aluminum tub and placed on a steel rod within the tub.
